(19) United States
(12) Patent Application Publication
(10) Pub. No.: US 2012/0307974 A1
(43) Pub. Date: Dec. 6, 2012

(54) X-RAY TUBE AND RADIATION IMAGING APPARATUS

(75) Inventors: Koji Yamazaki, Ayase-shi (JP); Ichiro Nomura, Atsugi-shi (JP); Shuji Aoki, Yokohama-shi (JP); Takao Ogura, Sagamihara-shi (JP); Yasue Sato, Machida-shi (JP); Yoshihiro Yanagisawa, Fujisawa-shi (JP); Kazuyuki Ueda, Tokyo (JP); Miki Tamura, Kawasaki-shi (JP)

(73) Assignee: CANON KABUSHIKI KAISHA, Tokyo (JP)

(21) Appl. No.: 13/469,305

(22) Filed: May 11, 2012

(30) Foreign Application Priority Data
May 31, 2011 (JP) 2011-121501

(51) Int. Cl. H01J 35/16; G01N 23/04

(52) U.S. Cl. 378/62; 378/121

(57) ABSTRACT

An X-ray tube comprises: an envelope which has a cathode at one end and an anode at another end of a barrel of a tubular insulating tube and which has a sealed interior; an electron gun which is arranged inside the envelope and has a shape that protrudes from the cathode; and a target which is electrically connected to the anode and generates X-rays when being irradiated with electrons emitted from the electron gun. With reference to an end position that is a projection of a position of an end on the anode side of the electron gun onto an inner wall of the insulating tube, a mean wall thickness of the barrel is greater on the cathode side than on the anode side.

### BACKGROUND OF THE INVENTION

1. Field of the Invention

The present invention relates to an X-ray tube applicable to medical and industrial X-ray generators and, in particular, to a transmissive X-ray tube that uses a transmissive target.

2. Description of the Related Art

A transmissive X-ray tube is a vacuum tube comprising a cathode, an anode, and an insulating tube. X-rays are generated by accelerating electrons emitted from an electron source of the cathode with a high voltage applied between the cathode and the anode and irradiating a target arranged at the anode with the accelerated electrons. The generated X-ray is emitted to the outside from the target that doubles as an X-ray extraction window.

With conventional X-ray tubes, voltage withstand capability have been an issue in achieving downsizing and weight reduction.

Japanese Patent Application Laid-open No. H09-180660 discloses a transmissive X-ray tube having voltage withstand capability improved by using a structure in which an end of a focusing electrode is sandwiched between and fixed by an insulating tube and a cathode and in which a gap is provided between an inner wall of the insulating tube and an outer surface of the focusing electrode.

In addition, Japanese Patent Application Laid-open No. H07-312189 discloses a reflective X-ray tube in which an inner diameter of a glass tube is expanded in a vicinity of a cathode portion to increase a distance between the cathode portion and an inner wall of the glass tube.

The technique described in Japanese Patent Application Laid-open No. H09-180660 has the following problem. A potential of the inner wall of the insulating tube arranged between the cathode and the anode is determined for each location by a dielectric constant (in some cases, a volume resistivity) of a material constituting the insulating tube. In such a case, depending on a distance between the outer surface of the focusing electrode and the inner wall of the insulating tube, a discharge may occur between the outer surface of the focusing electrode and the inner wall of the insulating tube and may become a barrier to achieving high voltage withstand capability and downsizing.

In addition, with the technique described in Japanese Patent Application Laid-open No. H07-312189, an increased outer diameter of the glass tube in the vicinity of the tip of the cathode portion together with an increased inner diameter of the glass tube makes downsizing difficult.

### SUMMARY OF THE INVENTION

In consideration of the above, it is an object of the present invention to provide an X-ray tube that achieves both improved voltage withstand capability and downsizing.

The present invention in its first aspect provides an X-ray tube including: an envelope which has a cathode at one end and an anode at another end of a barrel of a tubular insulating tube and which has a sealed interior; an electron gun which is arranged inside the envelope and has a shape that protrudes from the cathode to the interior; and a target which is electrically connected to the anode and generates X-rays when being irradiated with electrons emitted from the electron gun, wherein with reference to an end position that is a projection of a position of an end on the anode side of the electron gun onto an inner wall of the insulating tube, a mean wall thickness of the barrel is greater on the cathode side than on the anode side.

The present invention in its second aspect provides a radiation imaging apparatus comprising: a radiation generating apparatus including the X-ray tube comprising an envelope which has a cathode at one end and an anode at another end of a barrel of a tubular insulating tube and which has a sealed interior, an electron gun which is arranged inside the envelope and has a shape that protrudes from the cathode to the interior, and a target which is electrically connected to the anode and generates X-rays when being irradiated with electrons emitted from the electron gun, wherein with reference to an end position that is a projection of a position of an end on the anode side of the electron gun onto an inner wall of the insulating tube, a mean wall thickness of the barrel is greater on the cathode side than on the anode side; a radiation detector for detecting the radiation emitted from the radiation generating apparatus and transmitted through an object; and a control unit for controlling the radiation generating apparatus and the radiation detector.

According to the present invention, since a potential of an end position can be lowered and a field intensity between the end position and an outer surface of an electron gun can be reduced, an improved voltage withstand capability of the X-ray tube can be achieved and, at the same time, downsizing of the X-ray tube can be achieved in comparison to a case in which a wall thickness of the barrel of the insulating tube is increased over the entire barrel.

Further features of the present invention will become apparent from the following description of exemplary embodiments with reference to the attached drawings.

### BRIEF DESCRIPTION OF THE DRAWINGS

FIG. 1 is a configuration diagram of an X-ray tube according to the present invention;

FIG. 2 is a configuration diagram of another example of an X-ray tube according to the present invention;

FIG. 3 is a configuration diagram of another example of an X-ray tube according to the present invention;

FIG. 4 is a configuration diagram of an X-ray tube according to first and second comparative examples; and

FIG. 5 is a configuration view of a radiation imaging apparatus of a second embodiment.

### DESCRIPTION OF THE EMBODIMENTS

Hereinafter, a preferred embodiment of an X-ray tube according to the present invention will be exemplarily described with reference to the accompanying drawings. However, unless stated otherwise, materials, dimensions, shapes, relative arrangements, and the like of components described in the following embodiment are not to be construed as limiting the scope of the present invention thereto.

### First Embodiment

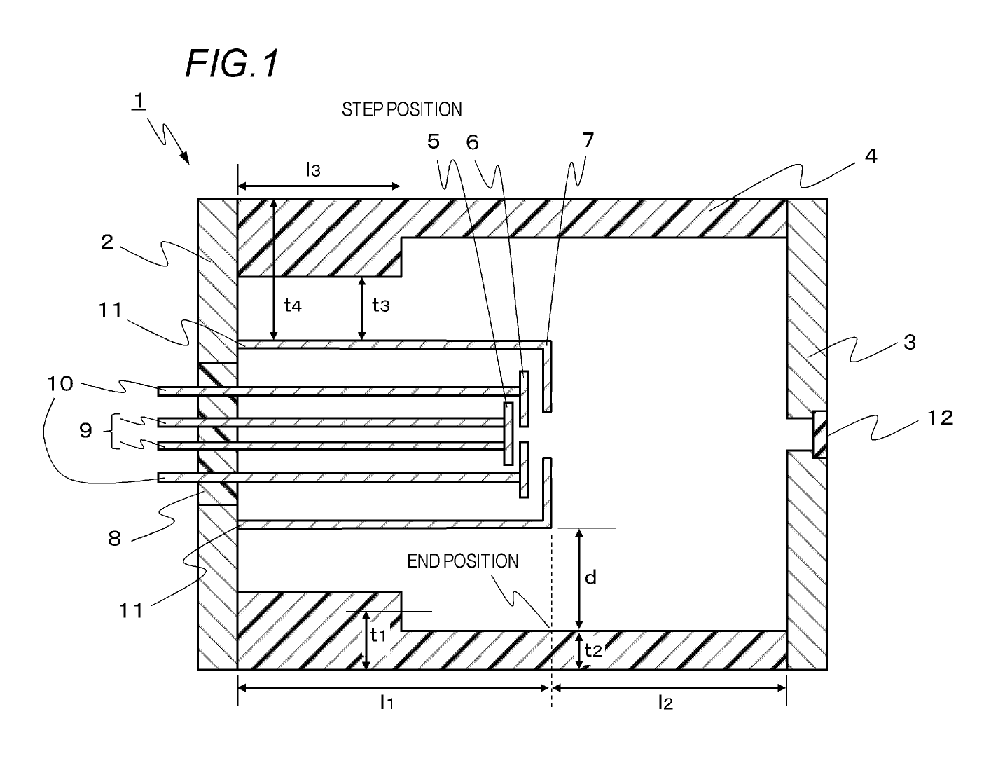

FIG. 1 is a configuration diagram of an X-ray tube according to the present embodiment and is a sectional schematic diagram of the X-ray tube according to the present embodiment cut along a plane including a cathode, an anode, an insulating tube, an electron gun, and a target.

An X-ray tube 1 is a vacuum tube comprising an envelope having a cathode 2 at one end and an anode 3 at another end of a barrel of a tubular insulating tube 4, an electron gun arranged inside the envelope, and a target arranged at the anode.

The cathode 2 is connected to the electron gun shaped so as to protrude from the cathode 2. The electron gun comprises an electron source 5, a grid electrode 6, a focusing electrode 7, an electron source driving terminal 9, a grid electrode terminal 10, and a focusing electrode terminal 11, and a gap is provided between an outer surface of the electron gun and an inner wall of the insulating tube 4. The term “outer surface of the electron gun” as used in the present embodiment refers to outer surfaces of an electrode and a terminal closest to the inner wall of the insulating tube 4 or, in other words, surfaces of the focusing electrode 7 and the focusing electrode terminal 11 on the inner wall side of the insulating tube 4. The “inner wall of the insulating tube 4” refers to an inner wall of a barrel of the insulating tube 4.

In addition, the cathode 2 comprises an insulating member 8. The electron source driving terminal 9 and the grid electrode terminal 10 are fixed to the insulating member 8 so as to be electrically insulated from the cathode 2. The electron source driving terminal 9 and the grid electrode terminal 10 extend from the electron source 5 and the grid electrode 6 in the X-ray tube 1 toward the cathode side and are extracted to the outside of the X-ray tube 1. The focusing electrode 7 is connected to the focusing electrode terminal 11 that is fixed to the cathode 2 and is regulated to a same potential as the cathode 2. Alternatively, the focusing electrode 7 may also be insulated from the cathode 2 and given a different potential from the cathode 2.

The electron source 5 is an electrode that emits electrons and is arranged so as oppose the target 12 on a tip of the electron source driving terminal 9 that extends protruding from the cathode 2. The electron source 5 may be formed integrally with the electron source driving terminal 9. While both a cold cathode and a hot cathode can be used as an electron emitting element of the electron source 5, an impregnated cathode (hot cathode) that enables extraction of a large current in a stable manner is favorably used as the electron source 5 that is applied to the X-ray tube 1 according to the present embodiment. When a heater in a vicinity of the electron emitting unit (emitter) is energized, the impregnated cathode increases cathode temperature and emits electrons.

The grid electrode 6 is an electrode to which a predetermined voltage is applied to extract electrons emitted from the electron source 5 into a vacuum, and is arranged separated from the electron source 5 by a predetermined distance so as to oppose the target 12 on a tip of the grid electrode terminal 10 that extends protruding from the cathode 2. The grid electrode 6 may be formed integrally with the grid electrode terminal 10. A shape, a bore diameter, a numerical aperture, and the like of the grid electrode 6 are determined in consideration of electron beam extraction efficiency and exhaust conductance in the vicinity of the cathode. Normally, a tungsten mesh with a wire diameter of around 50 μm can be favorably used.

The focusing electrode 7 is an electrode for controlling a spread (in other words, a beam diameter) of an electron beam extracted by the grid electrode 6, and is arranged so as oppose the target 12 on a tip of the focusing electrode terminal 11 that extends protruding from the cathode 2. The focusing electrode 7 maybe formed integrally with the focusing electrode terminal 11. Normally, a beam diameter is adjusted by applying a voltage of around several hundred V to several kV to the focusing electrode 7. Depending on a structure of a vicinity of the electron source 5 and an applied voltage, the focusing electrode 7 may be omitted and an electron beam may be focused solely by a lens effect of an electric field.

The anode 3 is electrically connected to the target 12. Besides thermal bonding, the bonding between the anode 3 and the target 12 is favorably performed by brazing or welding in consideration of maintaining a vacuum. Normally, a voltage of around several ten to a hundred kV is applied to the anode 3. An electron beam having predetermined energy which is generated by the electron source 5 and which is extracted by the grid electrode 6 is directed toward the target 12 on the anode 3 by the focusing electrode 7, accelerated by the voltage applied to the anode 3, and collides with the target 12. Due to the collision of the electron beam, X-rays are generated from the target 12 and radiated in all directions. Among the X-rays radiated in all directions, X-rays transmitted by the target 12 are extracted to the outside of the X-ray tube 1.

The target 12 may either have a structure constituted by a metallic film and a substrate supporting the metallic film or a structure solely constituted by a metallic film. When a structure constituted by a metallic film and a substrate supporting the metallic film is adopted, a metallic film that generates X-rays when collided by an electron beam is arranged on an electron beam irradiating surface (a surface on the electron gun side) of a substrate that transmits X-rays. Normally, a metallic material having an atomic number of 26 or higher can be used as the metallic film. Specifically, a thin film made of tungsten, molybdenum, chromium, copper, cobalt, iron, rhodium, rhenium, and the like or an alloy material thereof can be favorably used to form a dense film structure by physical deposition such as sputtering. While an optimum value of a film thickness of the metallic film differs since an electron beam penetration depth or an X-ray generation area differs depending on accelerating voltage, the metallic film normally has a thickness of around several to several ten μm when applying an accelerating voltage of around hundred kV. Meanwhile, the substrate must have high X-ray transmittance and high thermal conductivity and capable of withstanding vacuum lock, and diamond, silicon nitride, silicon carbide, aluminum carbide, aluminum nitride, graphite, beryllium and the like can be favorably used. Diamond, aluminum nitride, or silicon nitride which has a lower X-ray transmittance than aluminum and a higher thermal conductivity than tungsten are more favorably used. In particular, diamond surpasses other materials in terms of an extremely high thermal conductivity, a high X-ray transmittance, and an ability of vacuum retention. A thickness of the substrate need only satisfy the functions described above, and while thicknesses differ among materials, a thickness between 0.1 mm and 2 mm is favorable.

The insulating tube 4 is a tube with insulation properties that is formed of an insulating material such as glass or ceramics, and has a tubular shape. While the shape of the insulating tube 4 does not have too many restraints, a cylindrical shape is favorable in terms of downsizing and ease of fabrication. A square tube shape may be adopted instead. Both ends of the barrel of the insulating tube 4 are respectively bonded to the cathode 2 and the anode 3 by brazing or welding. When heating discharge is performed in order to improve the degree of vacuum in the X-ray tube 1, materials with similar coefficients of thermal expansion are favorably used for the cathode 2, the anode 3, the insulating tube 4, and the insulating member 8. For example, favorably, kovar or tungsten is used as the cathode 2 and the anode 3 and borosilicate glass or alumina is used as the insulating tube 4 and the insulating member 8.

In the present invention, downsizing and stabilization of the X-ray tube can be achieved by improving spatial voltage withstand capability between the inner wall of the insulating tube 4 and the outer surface of the electron gun. While spatial voltage withstand capability can be improved by weakening a field intensity between the inner wall of the insulating tube 4 and the outer surface of the electron gun, a method involving increasing a distance between the inner wall of the insulating tube 4 and the outer surface of the electron gun conflicts with downsizing of the X-ray tube. Therefore, the present invention proposes a method of weakening the field intensity between the inner wall of the insulating tube 4 and the outer surface of the electron gun by lowering a potential of the inner wall of the insulating tube 4. With this method, an improvement in spatial voltage withstand capability can be achieved by using, as a reference, a projection of a position of an anode-side end of the electron gun onto the inner wall of the insulating tube 4 (hereinafter, referred to as an “end position”) and setting a mean film thickness of the barrel of the insulating tube 4 on the cathode side greater than a mean film thickness of the barrel of the insulating tube 4 on the anode side. When a material with a high dielectric constant is used as the material constituting the insulating tube 4, statically, the potential of the inner wall of the insulating tube 4 is dominantly determined by the insulating tube 4. For example, alumina has a dielectric constant of around 10 and borosilicate glass has a dielectric constant of around 5. In addition, the closer to the anode which has a high potential, the higher the potential of the inner wall of the insulating tube 4. Therefore, in the present invention, using the end position as a reference, a mean wall thickness of the barrel of the insulating tube 4 on the cathode side is set greater than on the anode side. Accordingly, since a relative capacity of the insulating tube 4 is increased and the potential of the end position is lowered, an improvement in the voltage withstand capability of the X-ray tube can be achieved and, at the same time, downsizing of the X-ray tube can be achieved compared to a case in which a wall thickness of the barrel of the insulating tube 4 is increased over the entire barrel. Among members constituting the electron gun in the X-ray tube 1 according to the present embodiment, the focusing electrode 7 and the focusing electrode terminal 11 are arranged at positions closest to the inner wall of the insulating tube 4. In this case, the end position is a projection of a position of an anode-side end of the focusing electrode 7 onto the inner wall of the insulating tube 4. In addition, the anode-side end of the focusing electrode 7 need not necessarily protrude toward the inner wall of the insulating tube 4 than the focusing electrode terminal 11 as shown in FIG. 1, or may protrude toward the inner wall of the insulating tube 4 than the focusing electrode terminal 11.

In FIG. 1, the inner wall of the insulating tube 4 has a single step on the cathode side of the end position, and a mean wall thickness of the barrel of the insulating tube 4 is increased on the cathode side of the end position by bringing the inner wall of the insulating tube 4 closer to the outer surface of the electron gun. While it has been described above that downsizing can be achieved by setting a mean wall thickness of the barrel of the insulating tube 4 on the cathode side greater than that on the anode side with reference to the end position, by configuring the inner wall of the insulating tube 4 as shown in FIG. 1, further downsizing can be achieved since an outer wall of the insulating tube 4 does not project outward. Specifically, if a distance from the cathode 2 to the position of the step is denoted by l₃ and a distance from the cathode 2 to the end position is denoted by l₁, then a favorable configuration satisfies l₁/3<l₃<l₁. In addition, a configuration can be adopted which satisfies this condition and which, at the same time, satisfies t₄/10<t₃<t₄/2, where a distance from the outer wall of the insulating tube 4 to the outer surface of the electron gun is denoted by t₄ and a distance from the inner wall of the insulating tube 4 on the cathode side of the position of the step to the outer surface of the electron gun is denoted by t₃. When this configuration is adopted, a voltage withstand improvement effect can be obtained more reliably and further downsizing can be achieved. The “outer wall of the insulating tube 4” refers to an outer wall of the barrel of the insulating tube 4.

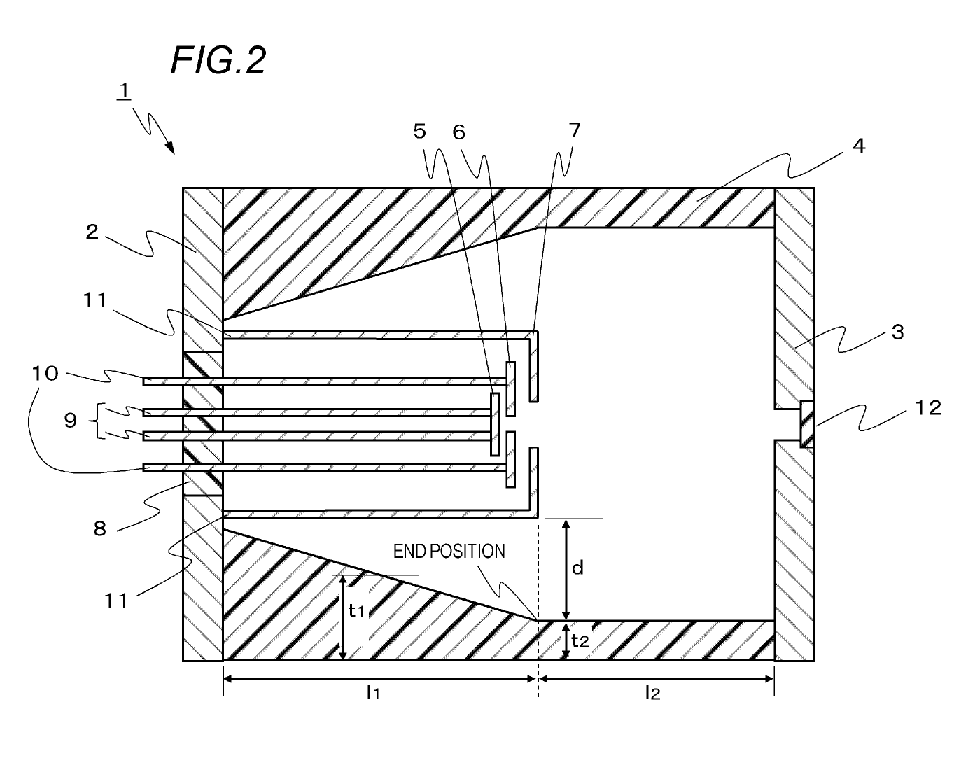

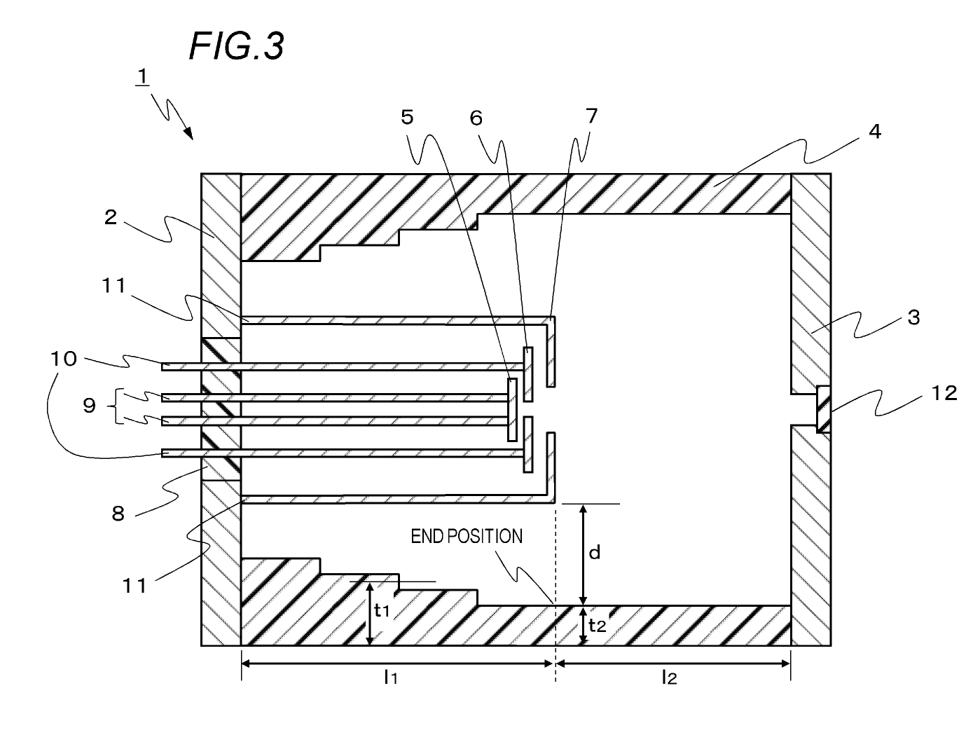

Next, other examples of the X-ray tube according to the present embodiment will be described. FIGS. 2 and 3 are configuration diagrams showing other examples of the X-ray tube according to the present embodiment (sectional schematic diagrams cut along the same plane as FIG. 1). In FIG. 2, the inner wall of the insulating tube 4 is inclined from the end position to the cathode 2, and a wall thickness of the barrel of the insulating tube 4 increases continuously from the end position toward the cathode. In FIG. 3, the inner wall of the insulating tube 4 has a plurality of steps on the cathode side of the end position. As the plurality of steps, two or more steps may suffice. By configuring the inner wall of the insulating tube 4 as shown in FIG. 2 or 3, since an increase in field intensity can be suppressed without having to suddenly reduce a distance between the inner wall of the insulating tube 4 and the outer surface of the electron gun on the cathode side of the end position, voltage withstand capability can be further improved.

In addition, even for the purpose of downsizing the X-ray tube 1, the field intensity between the end position and the anode-side end of the electron gun and the field intensity between the anode 3 and the anode-side end of the electron gun cannot exceed their respective limits at the same time. In particular, if a discharge occurs between the anode 3 and the anode-side end of the electron gun, there is a risk that the electron source 5 may suffer damage since the anode 3 becomes directly viewable from the electron source 5. Therefore, the field intensity between the anode 3 and the anode-side end of the electron gun is favorably equal to or lower than the field intensity between the end position and the anode-side end of the electron gun. More specifically, the following condition is favorably satisfied.

t₁(l₂−d)×l₁×t₂/(d×l₂),

where t₁ denotes a mean wall thickness of the barrel on the cathode side of the end position, t₂ denotes a mean wall thickness of the barrel on the anode side of the end position, l₁ denotes a distance from the cathode 2 to the end position, l₂ denotes a distance from the end position to the anode 3, and d denotes a distance from the end position to the anode-side end of the electron gun.

While an X-ray tube provided with the focusing electrode 7 has been described above, the present invention is also applicable even when the focusing electrode 7 is not provided. In this case, the grid electrode 6 becomes closest to the inner wall of the insulating tube 4. Therefore, the focusing electrode 7 in the above description may be considered being replaced with the grid electrode 6. Although there may be cases where the grid electrode 6 is absent depending on the mode of the electron source 5, even in such a case, the present invention can be applied using, as a reference, an end position that is a projection of a position of an anode-side end of an electrode closest to the inner wall of the insulating tube 4 onto the inner wall of the insulating tube 4. The focusing electrode 7 becomes closest to the inner wall of the insulating tube 4 when only the grid electrode 6 is absent, and the electron source 5 becomes closest to the inner wall of the insulating tube 4 when both the focusing electrode 7 and the grid electrode 6 are absent. In addition, the X-ray tube 1 described above can be used in various X-ray generators.

Hereinafter, while the present invention will be described with specific examples, it is to be understood that the present invention is not limited to the following examples.

### FIRST EXAMPLE

A configuration diagram of an X-ray tube according to the present example is shown in FIG. 1. Since a configuration of the X-ray tube shown in FIG. 1 is as described above, a description thereof will be omitted.

Kovar was used for the cathode 2 and the anode 3, alumina was used for the insulating tube 4 and the insulating member 8, and the components were bonded by welding. The insulating tube 4 was given a cylindrical shape. An impregnated cathode manufactured by Tokyo Cathode Laboratory Co., Ltd. was used as the electron source 5. The cathode has a columnar shape impregnated with an electron emitting unit (an emitter) and is fixed to an upper end of a tubular sleeve. A heater is mounted inside the sleeve, and when the heater is energized by the electron source driving terminal 9, the cathode is heated and electrons are emitted. The electron source driving terminal 9 was brazed to the insulating member 8.

The target 12 comprises a tungsten film with a film thickness of 5 μm formed on a silicon carbide substrate with a thickness of 0.5 mm, and was brazed to the anode 3. The grid electrode 6 and the focusing electrode 7 are arranged in order of proximity to the electron source 5 between the electron source 5 and the target 12. The grid electrode 6 is energized from the grid electrode terminal 10 and efficiently extracts electrons from the electron source 5. The grid electrode terminal 10 was brazed to the insulating member 8 in a similar manner to the electron source driving terminal 9. The focusing electrode 7 was integrally formed with the focusing electrode terminal 11. Hereinafter, the focusing electrode 7 and the focusing electrode terminal 11 will be collectively referred to and described as a “focusing electrode”. The focusing electrode was welded to the cathode 2 and regulated to a same potential as the cathode 2. The focusing electrode focuses a beam diameter of an electron beam extracted by the grid electrode 6 and irradiates the electron beam on the target 12 in an efficient manner.

The cathode 2, the anode 3, and the insulating tube 4 have an outer diameter of φ56 mm, and the focusing electrode has an approximately columnar outer shape with an outer diameter of φ25 mm. Respective centers of the cathode 2, the anode 3, the insulating tube 4, and the focusing electrode are aligned with each other. Since the insulating tube 4 has a length of 70 mm in an axial direction and the focusing electrode protrudes 40 mm beyond the cathode 2, an end position that is a projection of a position of the anode-side end of the focusing electrode onto the inner wall of the insulating tube 4 is 40 mm away from the cathode 2 along the inner wall of the insulating tube 4. The barrel of the insulating tube 4 has a wall thickness of 10 mm in a 20 mm range from the cathode 2 and a wall thickness of 5 mm in other portions. The barrel of the insulating tube 4 on the cathode side of the end position has a mean wall thickness t₁ of 7.5 mm and the barrel of the insulating tube 4 on the anode side of the end position has a mean wall thickness t₂ of 5 mm. A distance l₁ from the cathode 2 to the end position is 40 mm, a distance l₂ from the end position to the anode 3 is 30 mm, and a distance d from the end position to the anode-side end of the focusing electrode is 10.5 mm. A distance l₃ from the cathode 2 to the step position is 20 mm, a distance t₃ from the inner wall of the insulating tube 4 on the cathode side of the step position to the outer surface of the electron gun is 5.5 mm, and a distance t₄ from the outer wall of the insulating tube 4 to the outer surface of the electron gun is 15.5 mm.

Finally, while the X-ray tube 1 configured as described above was subjected to heating, air was discharged from an exhaust tube (not shown) welded to the cathode 2 and the X-ray tube 1 was sealed.

### FIRST COMPARATIVE EXAMPLE

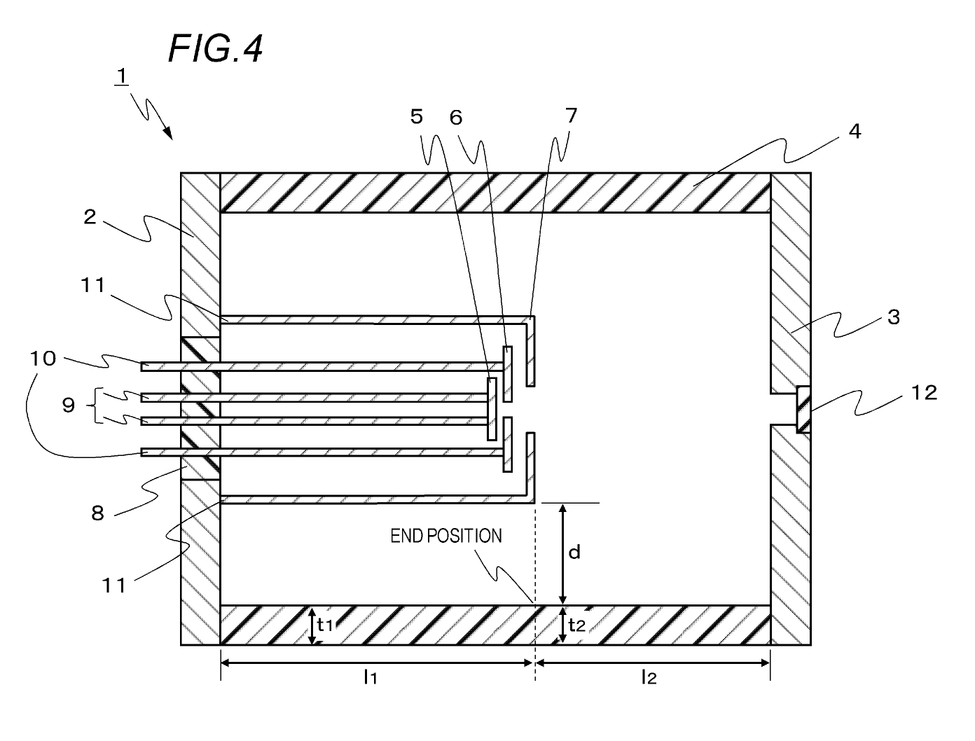

FIG. 4 shows a configuration diagram of an X-ray tube according to the present comparative example (a sectional schematic diagram cut along the same plane as FIG. 1). In the X-ray tube according to the present comparative example, a wall thickness of the barrel of the insulating tube 4 is constant from the cathode 2 to the anode 3. Materials constituting the respective members are the same as in the first example.

The cathode 2, the anode 3, and the insulating tube 4 have an outer diameter of φ60 mm, and the barrel of the insulating tube 4 has a constant wall thickness of 5 mm from the cathode 2 to the anode 3. The barrel of the insulating tube 4 on the cathode side of the end position has a mean wall thickness t₁ of 5 mm and the barrel of the insulating tube 4 on the anode side of the end position has a mean wall thickness t₂ of 5 mm. A distance l₁ from the cathode 2 to the end position is 40 mm, a distance l₂ from the end position to the anode 3 is 30 mm, and a distance d from the end position to the anode-side end of the focusing electrode is 12.5 mm.

### EVALUATION OF FIRST EXAMPLE

Between the first example and the first comparative example, ratios of field intensity between the end position and the anode-side end of the focusing electrode were 1:1.02 or, in other words, approximately equal to each other. In addition, a measurement of withstand voltages of the X-ray tube according to the first example and the X-ray tube according to the first comparative example revealed similar withstand voltages. Consequently, the X-ray tube according to the first example had achieved downsizing of 13% in volume ratio compared to the first comparative example without sacrificing voltage withstand capability.

### SECOND EXAMPLE

A configuration diagram of an X-ray tube according to the present example is shown in FIG. 2. The X-ray tube according to the present example differs from the first example in the outer diameters of the cathode 2, the anode 3, and the insulating tube 4, and in the shape of the inner wall of the insulating tube 4. Materials constituting the respective members are the same as in the first example.

The cathode 2, the anode 3, and the insulating tube 4 have an outer diameter of φ54 mm. A barrel of the insulating tube 4 has a wall thickness of 5 mm from the anode 3 to the end position, a wall thickness of 14 mm at an end on the cathode side, and a wall thickness that linearly and gradually increases from the end position to the end of the cathode. The barrel of the insulating tube 4 on the cathode side of the end position has a mean wall thickness t₁ of 9.5 mm and the barrel of the insulating tube 4 on the anode side of the end position has a mean wall thickness t₂ of 5 mm. A distance l₁ from the cathode 2 to the end position is 40 mm, a distance l₂ from the end position to the anode 3 is 30 mm, and a distance d from the end position to the anode-side end of the focusing electrode is 9.5 mm.

### EVALUATION OF SECOND EXAMPLE

Between the second example and the first example, ratios of field intensity between the end position and the anode-side end of the focusing electrode were 0.97:1 or, in other words, slightly lower in the second example. In addition, a measurement of withstand voltages of the X-ray tube according to the second example and the X-ray tube according to the first example revealed similar withstand voltages. Consequently, the X-ray tube according to the second example had achieved downsizing of approximately 20% in volume ratio compared to the first comparative example without sacrificing voltage withstand capability.

### THIRD EXAMPLE

The X-ray tube according to the present example uses the same materials and has the same configuration as the second example with the exception of borosilicate glass being used as the insulating tube 4.

### SECOND COMPARATIVE EXAMPLE

The X-ray tube according to the present comparative example uses the same materials and has the same configuration as the first comparative example with the exception of borosilicate glass being used as the insulating tube 4.

### EVALUATION OF THIRD EXAMPLE

A measurement of withstand voltages of the X-ray tube according to the third example and the X-ray tube according to the second comparative example revealed similar withstand voltages. Consequently, the X-ray tube according to the third example achieves downsizing of approximately 20% in volume ratio compared to the second comparative example without sacrificing voltage withstand capability.

### Second Embodiment

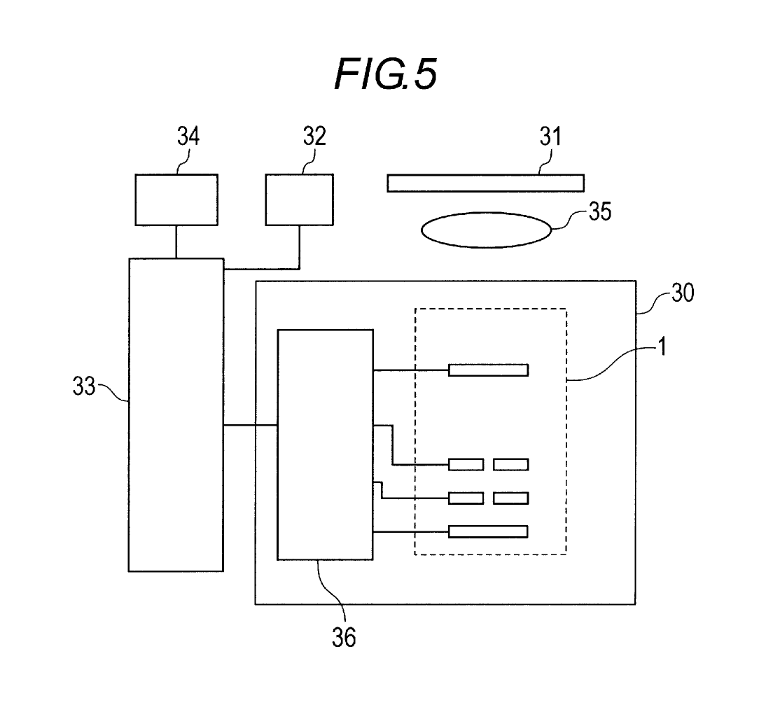

FIG. 5 is a configuration view of a radiation imaging apparatus of the second embodiment. The radiation imaging apparatus includes a radiation generating apparatus 30, a radiation detector 31, a signal processing unit 32, an apparatus control unit 33, and a display unit 34. The radiation generating apparatus 30 includes the X-ray tube 1 according to the first embodiment. The radiation detector 31 is connected to the apparatus control unit 33 through the signal processing unit 32. The apparatus control unit 33 is connected to the display unit 34 and the voltage control unit 36.

The process of the radiation generating apparatus 30 is integratedly controlled by the apparatus control unit 33. The apparatus control unit 33 controls radiation imaging by the radiation generating apparatus 30 and the radiation detector 31. The radiation emitted from the radiation generating apparatus 30 passes through an object 35 and is detected by the radiation detector 31, in which a radiation transmission image of the object 35 is taken. The taken radiation transmission image is displayed on the display unit 34. Further, the apparatus control unit 33 controls driving of the radiation generating apparatus 30 and controls a voltage signal applied to the X-ray tube 1 through the voltage control unit 36.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-121501, filed on May 31, 2011, which is hereby incorporated by reference herein in its entirety.

What is claimed is:

1. An X-ray tube comprising:
an envelope which has a cathode at one end and an anode at another end of a barrel of a tubular insulating tube and which has a sealed interior;
an electron gun which is arranged inside the envelope and has a shape that protrudes from the cathode to the interior; and
a target which is electrically connected to the anode and generates X-rays when being irradiated with electrons emitted from the electron gun, wherein
with reference to an end position that is a projection of a position of an end on the anode side of the electron gun onto an inner wall of the insulating tube, a mean wall thickness of the barrel is greater on the cathode side than on the anode side.

2. The X-ray tube according to claim 1, wherein
the inner wall of the insulating tube has a step on the cathode side of the end position, and
if a distance from the cathode to the position of the step is denoted by l₃ and a distance from the cathode to the end position is denoted by l₁, then l₁/3<l₃<l₁ is satisfied.

3. The X-ray tube according to claim 2, wherein
if a distance from an outer wall of the insulating tube to an outer surface of the electron gun is denoted by t₄ and a distance from the inner wall of the insulating tube on the cathode side of the position of the step to the outer surface of the electron gun is denoted by t₃, then t₄/10<t₃<t₄/2 is satisfied.

4. The X-ray tube according to claim 1, wherein
the inner wall of the insulating tube is inclined from the end position to the cathode, and
a wall thickness of the barrel increases continuously from the end position toward the cathode side.

5. The X-ray tube according to claim 1, wherein
the inner wall of the insulating tube has a plurality of steps on the cathode side of the end position.

6. The X-ray tube according to claim 1, wherein
if a distance from the cathode to the end position is denoted by l₁, a distance from the end position to the anode is denoted by l₂, a distance from the end position to the anode-side end of the electron gun is denoted by d, a mean wall thickness of the barrel on the cathode side of the end position is denoted by t₁, and a mean wall thickness of the barrel on the anode side of the end position is denoted by t₂, then the following condition is satisfied:
t₁(l₂−d)×l₁×t₂/(d×l₂).

7. A radiation imaging apparatus comprising:
a radiation generating apparatus including the X-ray tube comprising
an envelope which has a cathode at one end and an anode at another end of a barrel of a tubular insulating tube and which has a sealed interior,
an electron gun which is arranged inside the envelope and has a shape that protrudes from the cathode to the interior, and
a target which is electrically connected to the anode and generates X-rays when being irradiated with electrons emitted from the electron gun, wherein
with reference to an end position that is a projection of a position of an end on the anode side of the electron gun onto an inner wall of the insulating tube, a mean wall thickness of the barrel is greater on the cathode side than on the anode side;
a radiation detector for detecting the radiation emitted from the radiation generating apparatus and transmitted through an object; and
a control unit for controlling the radiation generating apparatus and the radiation detector.
